(19) United States
(12) Patent Application Publication
(10) Pub. No.: US 2018/0317385 A1
(43) Pub. Date: Nov. 8, 2018

(54) METHOD FOR EXECUTING AN AGRICULTURAL HARVESTING PROCESS

(71) Applicant: CLAAS Selbstfahrende Erntemaschinen GmbH, HARSEWINKEL (DE)

(72) Inventors: SCOTT WELLENSIEK, HARSEWINKEL (DE); JOACHIM BAUMGARTEN, BEELEN (DE)

(73) Assignee: CLAAS Selbstfahrende Erntemaschinen GmbH, HARSEWINKEL (DE)

(21) Appl. No.: 15/933,725

(22) Filed: Mar. 23, 2018

(30) Foreign Application Priority Data
May 8, 2017 (DE) 102017109849.6

(51) Int. Cl. A01D 41/127

(52) U.S. Cl. CPC A01D 41/127

(57) ABSTRACT

A method for executing an agricultural harvesting process on a field by an integrated system of agricultural harvesting machines, wherein the harvesting machines in the integrated system each comprise crop-processing working units which can be adjusted using machine parameters for adaptation to the particular harvesting conditions, wherein the harvesting machines in the integrated system communicate with each other via a wireless data network. One harvesting machine in the integrated system is designed as a self-optimizing harvesting machine which comprises a driver assistance system for automatically generating machine parameters which have been optimized with respect to the crop processing, and the optimized machine parameters are provided by the self-optimizing harvesting machine via the data network to the other harvesting machines in the integrated system that do not comprise a driver assistance system.

### CROSS-REFERENCE TO RELATED APPLICATIONS

This application claims priority from German Application No. 10 2017109849.6, filed on May 8, 2017, the disclosure of which is herein incorporated by reference.

### BACKGROUND OF THE INVENTION

The invention relates to a method for executing an agricultural harvesting process.

In large-dimensional fields to be harvested, an integrated system of agricultural harvesting machines is often utilized. In this case, the optimal operation of each harvesting machine in the integrated system is of particular significance, in order to maximize the efficiency of the harvesting process overall. This relates, in particular, to the working units of the harvesting machines, each of which is used for processing crop. These working units can be adjusted using machine parameters for adaptation to the particular harvesting conditions. The optimization of the machine parameters is of particular significance with respect to the aforementioned efficiency of the harvesting process.

The known method (U.S. Pat. No. 8,175,775 B2), on which the invention is based, relates to the execution of an agricultural harvesting process on a field by means of an integrated system of agricultural harvesting machines which communicate with each other via a wireless data network. In this case, it is very generally provided that the harvesting machine having the highest harvesting output, for example the highest crop throughput, is defined as the so-called master harvesting machine. The master harvesting machine provides its present machine parameters to the other harvesting machines via the data network.

In the known method, the high harvesting output can be based on factors that are poorly reproducible. These include, for example, a particularly experienced operator who is not constantly available, a field section that is present only locally and has a particularly high field crop density, or the like. The limited reproducibility with respect to the optimization is problematic, in particular, when an integrated system comprising a large number of harvesting machines is utilized.

### SUMMARY OF THE INVENTION

The problem addressed by the invention is therefore that of designing and refining the known method for executing an agricultural harvesting process in such a way that the reproducibility with respect to the optimization of the machine parameters of the harvesting machines is increased using simple means.

The aforementioned problem is solved in the case of a method for executing an agricultural harvesting process on a field by means of an integrated system of agricultural harvesting machines, wherein the harvesting machines in the integrated system each comprise crop-processing working units which can be adjusted using machine parameters for adaptation to the particular harvesting conditions. The harvesting machines in the integrated system communicate with each other via a wireless data network.

One harvesting machine in the integrated system is designed as a self-optimizing harvesting machine which comprises a driver assistance system for generating, in an automated manner, machine parameters which have been optimized with respect to the crop processing, and the optimized machine parameters are provided by the self-optimizing harvesting machine via the data network and are received by other harvesting machines in the integrated system that do not comprise a driver assistance system for generating, in an automated manner, machine parameters that have been optimized with respect to the crop processing.

Of essential importance is the fundamental finding that a high reproducibility with respect to the optimization of machine parameters can be best achieved when only that harvesting machine provides optimized machine parameters via the data network that has the best hardware preconditions for the determination of optimized machine parameters. Therefore, the optimization result is free from unforeseeable factors, which increases the reproducibility with respect to the optimization.

Specifically, it is provided that a harvesting machine in the integrated system is designed as a self-optimizing harvesting machine. In this case, this means that this harvesting machine comprises a driver assistance system for controlling machine parameters that have been optimized with respect to the crop processing. It is further essential that the optimized machine parameters are provided by the self-optimizing harvesting machine via the data network and are received by other harvesting machines in the integrated system that do not have a driver assistance system for generating, in an automated manner, machine parameters that have been optimized with respect to the crop processing.

In the solution according to the invention, it suffices that the entire integrated system comprises only one single harvesting machine which is self-optimizing in the aforementioned sense, while all other harvesting machines operate without a corresponding driver assistance system. This means it is possible, by way of the solution according to the invention, to achieve not only a particularly reproducible optimization of machine parameters, but also a reduction in the machine costs.

A preferred embodiment relates to the execution of the agricultural harvesting process by means of an integrated system of combine harvesters which comprise the working units header, feeder, threshing unit, separating device, release device, and spreading device. In the case of combine harvesters in particular, the generation of optimized machine parameters is complex, and therefore the aforementioned advantages of the method according to the invention become particularly clear in an integrated system of combine harvesters.

In another preferred embodiment, the equipment of the self-optimizing harvesting machine also includes at least one sensor for monitoring the crop processing and/or at least one sensor for monitoring the field ahead. The relevant sensor data form the basis for the automated generation of optimized machine parameters.

In another preferred embodiment, the optimized machine parameters relate to the header and represent the cutting height and/or the reel speed. The optimized machine parameters can also relate to the threshing unit and represent the cylinder speed and/or the concave width, or can relate to the separating device and represent separating device parameters, in particular a sieve width of the separating device. The optimized machine parameters can also relate to the cleaning device and represent the sieve width of the upper sieve and/or lower sieve and/or the blower output or can relate to the spreading device and represent spreading device parameters, in particular the throwing direction and throwing range.

At least one portion of the receiving harvesting machines comprises a reception controller, by means of which the working units are adjusted to the received, optimized machine parameters. The reception controller adapts the received, optimized machine parameters to the machine equipment of this harvesting machine. The working units are automatically adjusted to the received, optimized machine parameters by means of the reception controller. A fully automated adjustment of machine parameters is achieved this way therefore the reproducibility with respect to the optimization of the machine parameters increases further.

The reception controller can comprise a graphical, in particular, user interface, via which the received, optimized machine parameters are displayed. The received, optimized machine parameters can be modified, in an operator-controlled manner, by means of the user interface, and/or the working units can be adjusted to the received machine parameters in an operator-controlled manner by means of the user interface.

Assigned to the driver assistance system of the self-optimizing harvesting machine is at least one sensor for monitoring the field ahead, in particular a crop moisture sensor or a crop stand density sensor, and the sensor data for monitoring the field ahead are provided by the self-optimizing harvesting machine (3) via the data network (8) and are received by the other harvesting machines in the integrated system.

### BRIEF DESCRIPTION OF THE DRAWINGS

The invention is explained in the following in greater detail with reference to a drawing representing only one exemplary embodiment. In the drawing:

FIG. 1 shows an integrated system of agricultural harvesting machines which execute an agricultural harvesting process on a field according to a method according to the invention.

### DETAILED DESCRIPTION OF THE EMBODIMENTS

The method according to the invention is directed to the execution of an agricultural harvesting process on a field 1 by means of an integrated system 2 of agricultural harvesting machines 3-7, wherein the harvesting machines 3-7 in the integrated system 2 each comprise crop-processing working units which can be adjusted using machine parameters for adaptation to the particular harvesting conditions.

The harvesting machines 3-7 in the integrated system 2 communicate with each other via a wireless data network 8. In this case and preferably, the data network 8 is formed from radio-based, point-to-point connections. It is also conceivable, however, that the data network 8 is implemented at least in part via a mobile radio network.

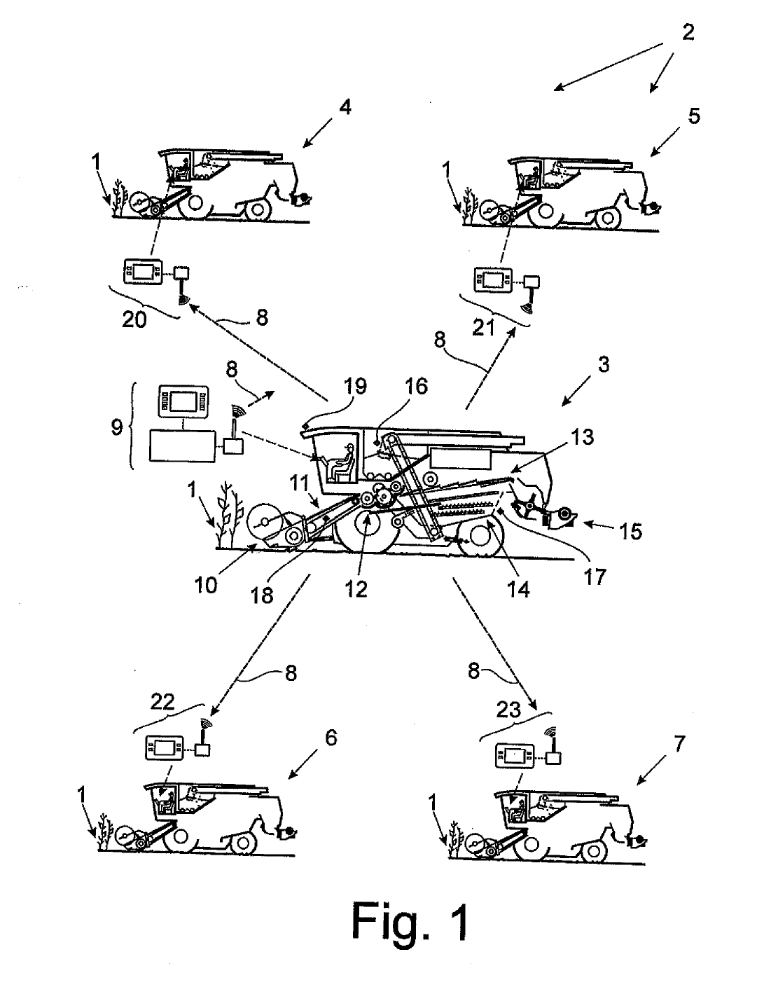

In the preferred integrated system 2 represented in FIG. 1, it is essential that precisely one harvesting machine 3 is given a prominent position. This is due to the fact that the harvesting machine 3 in the integrated system 2 is designed as a self-optimizing harvesting machine in the aforementioned sense and comprises a driver assistance system 9 for generating, in an automated manner, machine parameters that have been optimized with respect to the crop processing. Such a driver assistance system is known, for example, from EP 2 322 029 B1, which belongs to the applicant and which, in this regard, is made the subject matter of the present application.

The driver assistance system 9 preferably comprises a computing unit, on which a software runs for generating optimized machine parameters in an automated manner. The generation of optimized machine parameters preferably takes place based on different optimization criteria which can be defined and/or selected by the operator, in particular. The referenced driver assistance system is oriented in such a way, in particular, that the operator is integrated into the generation and/or selection of optimized machine parameters, for example, by way of the driver being able to accept or reject optimization proposals from the driver assistance system.

According to the invention, it is provided that the optimized machine parameters are provided by the self-optimizing harvesting machine 3 via the data network 8 and are received by other harvesting machines 4-7 in the integrated system 2 that do not have a driver assistance system for generating, in an automated manner, machine parameters that have been optimized with respect to the crop processing. This means, the direction of the data flow from the harvesting machine 3 to the other harvesting machines 4-7 is due solely to the fact that the harvesting machine 3 comprises a driver assistance system 9 and, therefore, is self-optimizing, and the other harvesting machines 4-7 do not comprise a driver assistance system 9 and, therefore, are not self-optimizing. According to the invention, the direction of the data flow is therefore determined based exclusively on the machine equipment of the harvesting machines 3-7, without the direction of data flow being directly dependent on the particular present harvesting output.

In this case and preferably, the harvesting machines 3-7 in the integrated system 2 are combine harvesters. In principle, however, any other type of harvesting machines can be used in this case. All embodiments of a harvesting machine designed as a combine harvester apply for all other types of harvesting machines.

A combine harvester preferably comprises the working units header 10, feeder 11, threshing unit 12, separating device 13, cleaning device 14, and spreading device 15, as represented by way of example in conjunction with the harvesting machine 3. The harvesting machine 3 comprises, in its front area, the header 10 which is connected to the feeder 11 in a way which is known per se. The crop stream passing through the feeder 11 is fed to a threshing unit 12 and, subsequent thereto, is transferred to the separating device 13 for separating out the freely movable grains contained in the crop stream. Situated downstream from the separating device 13 is a cleaning device 14 which is equipped with an upper sieve and a lower sieve, which are not shown. Finally, the resultant straw portion is spread via the spreading device 15 on the field 1.

The generation of optimized machine parameters by the driver assistance system 9 of the harvesting machine 3 preferably takes place based on sensor data. For this purpose, assigned to the driver assistance system 9 of the self-optimizing harvesting machine 3 is at least one sensor 16, 17 for monitoring the crop processing and/or at least one sensor 18, 19 for monitoring the field ahead, wherein the driver assistance system 9 determines the optimized machine parameters based on the sensor measured values. In the example of a combine harvester, the sensor 16, 17 for monitoring the crop processing is preferably a damaged-grain sensor for determining the portion of damaged grain, or the sensor is a grain loss sensor 17 for determining the portion of grain thrown on the field 1. The sensor 18, 19 for monitoring the field ahead is preferably a crop moisture sensor 18 or a crop stand density sensor 19. Other sensors are usable, in principle, during the generation of optimized machine parameters.

As mentioned above, the optimized machine parameters relate to one of the aforementioned working units 10-15 of the harvesting machines 3-7.

Specifically, the optimized machine parameters preferably relate to the header 10. In this case, the machine parameters preferably represent the cutting height and/or the reel speed. Alternatively or additionally, it is provided that the optimized machine parameters relate to the threshing unit 12 and represent the cylinder speed and/or the concave width. Further alternatively or additionally, it can be provided that the optimized machine parameters relate to the separating device and represent the separating device parameters, in particular a sieve width of the separating device. It is also preferably provided, alternatively or additionally, that the optimized machine parameters relate to the cleaning device 14 and represent the sieve width of the upper sieve and/or the lower sieve and/or represent the blower output. Finally, it is preferably provided, alternatively or additionally, that the optimized machine parameters relate to the spreading device 15 and represent spreading device parameters, in particular the throwing direction and throwing range for the straw portion. Other machine parameters are conceivable, in principle, for the optimization according to the invention.

At least one portion of the receiving harvesting machines 4-7, specifically all receiving harvesting machines 4-7 in this case, comprise a reception controller 20-23, by means of which the working units of the relevant, receiving harvesting machines 4-7 are adjusted to the received, optimized machine parameters. The reception controller 20-23 can be a component of a higher-level machine controller.

In principle, it can be further provided that the reception controller 20-23 of a harvesting machine 4-7 simply passes the received, optimized machine parameters through to the relevant working units of the receiving harvesting machine 4-7. In this case and preferably, however, the reception controller 20-23 of a harvesting machine 4-7 adapts the received, optimized machine parameters to the machine equipment of this harvesting machine 4-7. The reason for such an adaptation can be that the receiving harvesting machines 4-7 can be dimensioned differently, in principle, than the self-optimizing harvesting machine 3. For example, the cylinders of the threshing units 12 of the self-optimizing harvesting machine 3, on the one hand, and of the other harvesting machines 4-7, on the other hand, can be dimensioned differently, which makes it necessary to adapt the optimized cylinder speed and/or concave width provided by the self-optimizing harvesting machine 3.

According to one particularly user-friendly, preferred embodiment, the working units of the relevant harvesting machines 4-7 are automatically adjusted to the received, optimized machine parameters by means of the reception controller 20-23. An intervention into the changing of the machine parameters by the operator is not provided in this case.

In principle, it is also, conceivable, however, that the reception controller 20-23 comprises a graphical user interface, in this case and preferably, via which the received, optimized machine parameters are displayed. By way thereof, the operator can be informed about a change in the machine parameters.

In addition, it is conceivable that the received, optimized machine parameters can be modified, in an operator-controlled manner, by means of the user interface. In this way, the operator, can introduce modifications into the machine parameters, based on his own experience, and simultaneously make use of the optimization result of the self-optimizing harvesting machine 3. Alternatively or additionally, it can be provided that the working units of the receiving harvesting machine 4-7 are adjusted to the received machine parameters in an operator-controlled manner by means of the user interface. In other words, the operator can accept or reject the optimized machine parameters provided by the self-optimizing harvesting machine 3 for his/her own harvesting machine 4-7.

As indicated above, the solution according to the invention can integrate the operator in highly different ways. Provided the experience of the operator is to be utilized comprehensively on the harvesting machines 4-7, the relevant operator is to be provided with a corresponding base of information. This is provided for the case, for example, that at least one aforementioned sensor 18, 19 for monitoring the field ahead is assigned to the driver assistance system 9 of the self-optimizing harvesting machine 3. In this case, the sensor data for monitoring the field ahead are preferably provided by the self-optimizing harvesting machine 3 via the data network 8 and are received by the other harvesting machines 4-7 of the integrated system 2. In this case, it is also preferably provided that the receiving harvesting machines 4-7 display the sensor data related to the monitoring of the field ahead via an aforementioned user interface of the reception controller 20-23, and therefore the operator can carry out a modification of the machine parameters based on this information provided by the self-optimizing harvesting machine 3.

### LIST OF REFERENCE SIGNS

1 field
2 integrated system
3-7 harvesting machine
8 data network
9 driver assistance system
10 header
11 feeder
12 threshing unit
13 separating device
14 cleaning device
15 spreading device
16 damaged-grain sensor
17 grain loss sensor
18 crop moisture sensor
19 crop stand density sensor
20-23 reception controller

What is claimed is:

1. A method for executing an agricultural harvesting process on a field by means of an integrated system of agricultural harvesting machines, wherein the harvesting machines in the integrated system each comprise crop-processing working units which can be adjusted using machine parameters for adaptation to the particular harvesting conditions, wherein the harvesting machines in the integrated system communicate with each other via a wireless data network, comprising the following steps:
automatically generating machine parameters which have been optimized with respect to the crop processing by one harvesting machine in the integrated system, said one harvesting machine being designed as a self-optimizing harvesting machine which comprises a driver assistance system;
providing said optimized machine parameters by the self-optimizing harvesting machine via the data network; and
receiving the optimized machine parameters by other harvesting machines in the integrated system that do not comprise a driver assistance system for generating, in an automated manner, machine parameters that have been optimized with respect to the crop processing for each of said other harvesting machines.

2. The method as claimed in claim 1, wherein the harvesting machines in the integrated system are designed as combine harvesters each comprising working units of header, feeder, threshing unit, separating device, cleaning device, and spreading device, and wherein the optimized machine parameters relate to at least one of these working units.

3. The method as claimed in claim 1, wherein assigned to the driver assistance system of the self-optimizing harvesting machine is at least one sensor for monitoring crop processing, and/or at least one sensor for monitoring the field ahead, and wherein the driver assistance system determines the optimized machine parameters based on measured values from the sensor.

4. The method as claimed in claim 2, wherein the optimized machine parameters relate to the header and represent cutting height and/or reel speed.

5. The method as claimed in claim 2, wherein the optimized machine parameters relate to the threshing unit and represent cylinder speed and/or concave width.

6. The method as claimed in claim 2, wherein the optimized machine parameters relate to the separating device and represent a sieve width of the separating device.

7. The method as claimed in claim 2, wherein the optimized machine parameters relate to the cleaning device and represent a sieve width of an upper sieve and/or lower sieve and/or a blower output.

8. The method as claimed in claim 2, wherein the optimized machine parameters relate to the spreading device and represent a throwing direction and throwing range.

9. The method as claimed in claim 1, wherein at least one portion of each of the other harvesting machines comprises a reception controller, by means of which the working units are adjusted to the received, optimized machine parameters.

10. The method as claimed claim 9, wherein the reception controller adapts the received, optimized machine parameters to machine equipment of the respective harvesting machine.

11. The method as claimed claim 9, wherein the reception controller automatically adjusts the working units to the received, optimized machine parameters.

12. The method as claimed claim 9, wherein the reception controller comprises a graphical interface via which the received optimized machine parameters are displayed.

13. The method as claimed in claim 12, further comprising the step of modifying the received, optimized machine parameters in an operator-controlled manner by means of the user interface, and/or adjusting the working units to the received machine parameters in an operator-controlled manner by means of the user interface.

14. The method as claimed in claim 2, wherein assigned to the driver assistance system of the self-optimizing harvesting machine is at least one sensor for monitoring the field ahead, and wherein sensor data for monitoring the field ahead are provided by the self-optimizing harvesting machine via the data network and are received by the other harvesting machines in the integrated system.
